(19) United States
(12) Patent Application Publication
(10) Pub. No.: US 2023/0098140 A1
(43) Pub. Date: Mar. 30, 2023

(54) INDUCTIVE POSITION SENSOR

(71) Applicant: HELLA GmbH & Co. KGaA, Lippstadt (DE)

(72) Inventors: Johannes NORDHORN, Herzebrock-Clarholz (DE); Fabian UTERMOEHLEN, Lippstadt (DE); Steffen THAMER, Bochum (DE); Harry WEBER, Lippstadt (DE)

(73) Assignee: HELLA GmbH & Co. KGaA, Lippstadt (DE)

(21) Appl. No.: 18/076,483

(22) Filed: Dec. 7, 2022

Related U.S. Application Data
(63) Continuation of application No. PCT/EP2021/064066, filed on May 26, 2021.

(30) Foreign Application Priority Data
Jun. 10, 2020 (DE) 10 2020 115 424.0

(51) Int. Cl. H02K 11/225; H02K 11/26; H02K 11/00

(52) U.S. Cl. CPC H02K 11/225; H02K 11/26; H02K 11/0094

(57) ABSTRACT

An inductive position sensor, having a first stator element that comprises a first excitation coil, to which a periodic alternating voltage is applied, and also comprises a first receiving system, wherein the signal from the first excitation coil couples inductively into the first receiving system. A first rotor element influence the strength of the inductive coupling between the first excitation coil and the first receiving system as a function of its angular position relative to the first stator element. A metal element and the first rotor element are arranged on a shaft in a rotationally fixed manner. An evaluation circuit determines the angular position of the first rotor element relative to the first stator element from the voltage signals induced in the first receiving system. The first rotor element and the metal element are each designed as a conductor loop with a periodic geometry.

This nonprovisional application is a continuation of International Application No. PCT/EP2021/064066, which was filed on May 26, 2021, and which claims priority to German Patent Application No. 10 2020 115 424.0, which was filed in Germany on Jun. 10, 2020, and which are both herein incorporated by reference.

### BACKGROUND OF THE INVENTION

### Field of the Invention

The present invention relates to an inductive position sensor, in particular for a motor vehicle, having a first stator element that comprises a first excitation coil, to which a periodic alternating voltage is applied, and also comprises a first receiving system, wherein the signal from the first excitation coil couples inductively into the first receiving system, having a first rotor element that influences the strength of the inductive coupling between the first excitation coil and the first receiving system as a function of its angular position relative to the first stator element, having a metal element that can influence the inductive coupling between the first excitation coil and the first receiving system, wherein the metal element is connected to the first rotor element in a rotationally fixed manner on a common shaft, and having an evaluation circuit for determining the angular position of the first rotor element relative to the first stator element from the voltage signals induced in the first receiving system.

### Description of the Background Art

Inductive position sensors are used in modern motor vehicles in an extremely wide variety of applications with a multiplicity of boundary conditions. In particular, inductive position sensors are used where an angular position of a rotor is to be sensed in order to permit precise control. This can be necessary, for example, at a steering column, a brake system, or a drive train for motor vehicles, particularly electric and hybrid vehicles.

During the design of inductive position sensors and integration of the sensors into existing vehicle systems, it is necessary to consider the sensor's environment since metal elements, in particular, that are located in the vicinity of the inductive position sensor can influence the inductive coupling between the first excitation coil and the first receiving system, which can cause the voltage signals induced in the receiving system to be influenced.

In order to nevertheless be able to use inductive position sensors in such an environment, therefore, appropriate measures that minimize the influence of the metal elements are required.

Inductive position sensors are known from the prior art that have shielding in order to reduce the interfering influences of the metal element. The higher costs that raise the price of the sensor as a result of shielding the sensor from metal elements are a particular disadvantage of this approach. Such shielding must be configured individually for each application, which generally is accomplished through empirical testing. Such shielding can be formed by a metal layer, metal grid, or metal mesh in a printed circuit board, for example. Normally this shielding is designed as an additional layer of a multilayer printed circuit board on which the first stator element is arranged. The possibilities provided by these measures are limited. A reduction in the influence can be achieved through this shielding. However, it is not possible to completely eliminate the interfering influence.

This is the starting point for the present invention.

### SUMMARY OF THE INVENTION

It is therefore an object of the present invention to improve the known position sensors, in particular for motor vehicles, such that the influence of a metal element is minimized and at the same time the sensors can be manufactured cost-effectively.

The object is attained according to an exemplary embodiment of the invention in that the first rotor element and the metal element are each designed as a conductor loop with a periodic geometry, and the periodicities of the first rotor element and the metal element have a specified integer ratio.

As a result, the influence of the metal element on the voltage signals induced in the first receiving system can be minimized by the geometry of the first rotor element and of the metal element and the ratio of the periodicities.

In the inductive position sensor according to the invention, it is possible that the influence of the metal element on the induced voltage signals is canceled out by the design of the first rotor element and of the metal element as conductor loops and specified integer periodicities relative to one another. As a result, it is possible to dispense with shielding.

The possibility exists that the first stator element is arranged on a printed circuit board, wherein the printed circuit board is located in a space between the first rotor element and the metal element and at a distance therefrom, and the printed circuit board is permeable to electric and/or magnetic fields and/or electromagnetic waves since no shielding is provided in the printed circuit board.

As a result of dispensing with shielding within the printed circuit board, it is possible to dispense with an additional layer. Since every additional layer entails expense, it is desirable to design the printed circuit board to be as compact as possible.

Provision can be made that the geometry of the conductor loop of the first rotor element and of the metal element can be described by two circular paths with different radii about center points on the common shaft, wherein a first radius of a first of the two circular paths is smaller than a second radius of a second of the two circular paths, and one section at a time of the conductor loop runs on the first or the second circular path periodically in alternation, and the ends of the sections are connected to the respective adjacent sections on the other respective circular path by a radial connection between the circular paths.

The resultant geometry of the first rotor element and of the metal element corresponds to the outer contour of a rotor with a number of vanes and gaps. Provision can therefore be made that in each case the section of the conductor loop on the circular path with the second radius forms a vane, and in each case the section of the conductor loop on the circular path with the first radius forms a gap, wherein one vane and one gap in each case determine the periodicity of the first rotor element and of the metal element.

In order to minimize the influence of the metal element on the first receiving system, it can be advantageous that the ratio of the periodicities of the first rotor element and the metal element is 1:2 or 2:1.

This means that the periodicity of the first rotor element corresponds to either half or double the periodicity of the metal element. The combination of the geometry and the periodicity results in a minimization of the influence in this case.

The possibility exists that the first receiving system has at least two, preferably three, first conductor loops. In addition, provision can be made that the first conductor loops each form a periodically repeating loop structure. Especially advantageously, provision can be made that the winding direction of the first conductor loops of the periodically repeating loop structure changes, wherein an area is spanned as a result of the change in the winding direction. As a result of the change in the winding direction, the integration path of the areas periodically spanned by the first conductor loops changes. The magnetic field coupled into the first receiving system by the first rotor element results in a signal voltage amplitude at the conductor loop that is proportional to the expression ∫BᵣdA (Bᵣ: magnetic field strength in the first conductor loop caused by the rotor element, A: area spanned by the first conductor loop). As a result of the change in the winding direction, the orientation of the surface normal dA changes, which has the result that the sign of the calculated integral is alternately positive and negative.

The periodicity of the loop structure of each first conductor loop can match the periodicity of the geometry of the first rotor element. In this case, the sign of the coupled-in magnetic field changes with the same periodicity as the sign of the first conductor loops. If the coupled-in signal is equal in the periodically spanned areas, then the signal components cancel each other out.

The first rotor element and/or the metal element can be designed as a stamped part and/or laser-cut part. The manufacturing method as a stamped part, in particular, permits the production of large quantities, which can result in cost optimization. Design as a laser-cut part permits, in particular, high flexibility in manufacture and the possibility to accommodate special requirements.

The metal element can be designed as a second rotor element. By means of such a construction of the inductive position sensor it would be possible, for example, to measure two angles of rotation on one shaft, for example in order to determine the torsion of the shaft, for example of a steering column of a motor vehicle.

A second stator element can have a second excitation coil and a second receiving system with at least two, preferably three, second conductor loops, wherein the signal from the second excitation coil couples into the second receiving system, wherein the strength of the signal is determined by the second rotor element. In this case it would be possible to determine a value for the second rotor element and place it in relationship with the first rotor element.

Furthermore, a second stator element can have a second receiving system with at least two, preferably three, second conductor loops, wherein the signal from the first excitation coil couples into the second receiving system, and wherein the strength of the signal is influenced by the second rotor element. The first excitation coil then generates the signal both for the first receiving system and for the second receiving system. In this case, the second excitation coil can also be dispensed with.

The second stator element can be arranged on the printed circuit board. In this case, a space-saving construction of the inductive position sensor is possible.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a side view of a schematic representation of an inductive position sensor according to an exemplary embodiment of the present invention;

FIG. 2 is a schematic representation of a rotor element and/or of a metal element;

FIG. 3 is a schematic representation of the structures of rotor element and metal element as well as of the first receiving system for a first ratio of the periodicities with associated orientation of the magnetic field and of the surface normal dA; and

FIG. 4 is a schematic representation of the structures of rotor element and metal element as well as of the first receiving system for a second ratio of the periodicities with associated orientation of the magnetic field and of the surface normal dA.

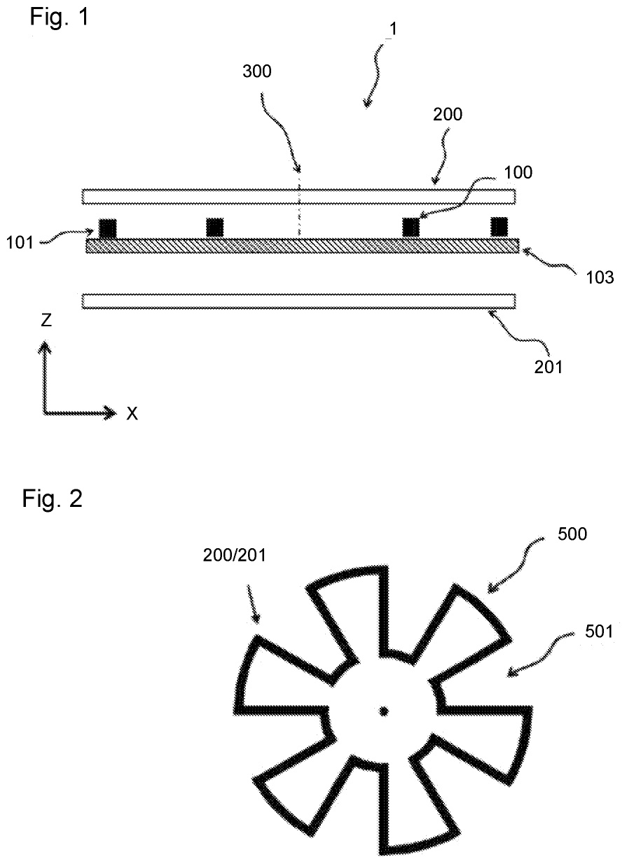

### DETAILED DESCRIPTION

An inductive position sensor 1, which is constructed according to an exemplary embodiment of the present invention, includes a printed circuit board 103 on which the first stator element is arranged.

In addition, the inductive position sensor 1 includes a first rotor element 200 and a metal element 201, wherein the printed circuit board 103 is arranged between the first rotor element 200 and the metal element 201, at a distance from both of them. The rotor element 200 and the metal element 201 are positioned coaxially on a common shaft 300. The first rotor element 200 and the metal element 201 are arranged so as to be rotatable relative to one another and relative to the printed circuit board 103.

On its side facing the first rotor element 200, the printed circuit board 103 has the first stator element, which includes a first excitation coil 101 and a first receiving system 100. The first receiving system 100 includes two, preferably three, first conductor loops. The first conductor loops form a periodically repeating loop structure, which spans an area by means of a change in the winding direction.

The inductive position sensor 1 has an oscillator circuit that generates a periodic alternating voltage signal and couples it into the first excitation coil 101 during operation of the inductive position sensor 1. During its rotation, the first rotor element 200 influences the strength of the inductive coupling between the first excitation coil 101 and the first receiving system 100.

As a result of the influencing of the strength of the inductive coupling between first excitation coil 101 and first receiving system 100 by the first rotor element 200 as a function of its angular position relative to the first stator element, the angle between first rotor element 200 and first receiving system 100 can be determined. This angle is of ever increasing importance for many applications, in particular in a motor vehicle. The inductive position sensor 1 has an evaluation circuit for determining the angular position of the first rotor element 200 relative to the stator element from the signals coupled into the first receiving system 100.

The metal element 201, which is arranged on the other side of the printed circuit board 103, can influence the inductive coupling between first excitation coil 101 and first receiving system 100. This influence is undesirable, since it is superimposed on the influence of the first rotor element 200 and impedes an exact determination of the angular position between first rotor element 200 and first receiving system 100.

In order to minimize the influence of the metal element 201, the inductive position sensor 1 has a first rotor element 200 and a metal element 201, each of which is designed as a conductor loop with a periodic geometry, and the periodicity of the first rotor element 200 and the metal element 201 have a specified integer ratio to one another. It has become apparent that it is especially advantageous when the ratio of the periodicities is 1:2 or 2:1.

Furthermore, the periodicity of the first rotor element 200 matches the periodicity of the loop structure of one conductor loop of the first receiving system 100 in each case.

FIG. 2 shows the schematic structure of a first rotor element 200 and/or of a metal element 201, wherein the metal element 201 corresponds essentially to the geometry of the first rotor element 200 and the two can differ by their periodicity.

As can be seen in FIG. 2, the outer contour of the first rotor element 200 or of the metal element 201 is reproduced by the conductor loop. The sections of the conductor loop on the outer radius of the element can be seen. These can be taken as vanes. The sections of the conductor loop on the inner radius can be taken as gaps. In this context, one vane and one gap define the periodicity in each case.

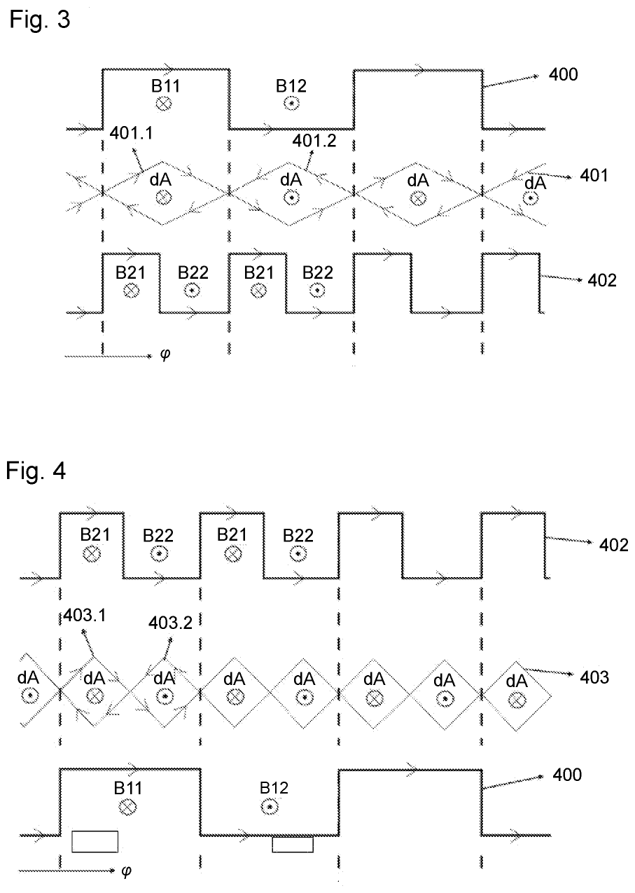

Owing to the integer ratio of the periodicities between first rotor element 200 and metal element 201 as well as the geometry of the two elements, the influence of the metal element 201 on the voltage signals induced in the first receiving system 100 can be minimized. It is possible to eliminate the influence almost completely. For the purpose of illustration, FIG. 3 shows a schematic representation of the structures of first rotor element 200 and metal element 201 as well as of the first receiving system 100 for two periodicities with associated orientation of the magnetic field and of the surface normal dA.

In essence, two application cases occur with a desired ratio of the periodicities of 1:2 or 2:1. These two application cases are considered with a different periodicity in FIGS. 3 and 4. FIG. 3 and FIG. 4 show possible structures 400, 402 of a first rotor element 200 and/or of a metal element 201 and two possible different structures 401, 403 of a first receiving system 100. The arrows drawn in the structures 400, 401, 402, 403 correspond here to the integration path, or the assumed direction of current. The representation takes place along the angle of rotation φ.

The possible first receiving systems 401 and 403 formed here of the periodic repetition of the two area halves 401.1 and 401.2, or 403.1 and 403.2, wherein the respective halves have a different surface normal dA on account of the change in winding direction. The influence of the metal element 201 on the first receiving system 100 shall now be considered for the combinations shown in FIG. 3 and FIG. 4 of the structures 400, 401, 402, 403 of the rotor element 200 and of the metal element 201 as well as a first receiving system 100.

FIG. 3 shows the application case that the periodicities of the first rotor element 200 and of the metal element 201 have a ratio of 1:2. In FIG. 3, the first receiving system 100 corresponds to the structure 401 and the first rotor element 200 corresponds to the rotor structure 400. The metal element 201 is shown with the structure 402. It can be seen that the periodicity of the metal element 402 is smaller than the periodicity of the first receiving system 100.

FIG. 4 shows the application case that the periodicities of the first rotor element 200 and of the metal element 201 have a ratio of 2:1. In FIG. 4, the metal element 201 is implemented with the structure 400, the first rotor element 200 with the rotor structure 402, and the first receiving system 100 with the structure 403. It can be seen in this second case that the periodicity of the metal element 201 is larger than the periodicity of the first receiving system 100.

In both cases the periodicities of the metal element 201 and of the first rotor element 200 have an integer ratio to one another. The first rotor element and the first receiving system 100 have the same periodicities in the two cases considered. Thus, the periodicity of the metal element 201 in FIG. 3 corresponds to half the periodicity of the first receiving system 100, and in FIG. 4 to double the periodicity.

In FIG. 3 it can be seen that the periodicity of the metal element 201 with the structure 402 corresponds to half the structure width 401.1. The influence of the metal element 201 is thus identical in magnitude in the respective halves 401.1 and 401.2 for any angular relationships between the metal element 201 and the first receiving system 100. On account of the different orientations of the surface normals dA, they have opposite signs, however, so that the two contributions cancel out exactly. It also must be recognized here that a variation in the geometry in the first receiving system 401, for example due to an additional distance between the outgoing and return windings, as well as a variation in the rotor structure 402, for example due to variation in the vane width, essentially compensate for one another.

In FIG. 4 it can be seen that the periodicity of the metal element 201 with the structure 400 corresponds to double the structure width 403.1. The influence of the metal element 201 in this case is identical in magnitude in the two halves 403.1 and 403.2. On account of the different orientations of the surface normals dA, the two contributions have opposite signs. It must be recognized, however, that even small deviations, such as a greater width of the vanes 500 in the rotor structure 400, for instance, have the result that the contributions change in magnitude and are no longer identical. Consequently, an influence of the metal element 201 with the structure 400 would arise on the first receiving system 100 with the structure 403. Since the first receiving system 100 is essentially implemented on a printed circuit board 103 with multiple layers, such influences must be taken into account. By adjusting the periodicity of the metal element 400, a minimum of the influence can be determined. In this context, the minimum can essentially be found on the basis of simulations or measurements. Through appropriate choice of the periodicity, it is therefore possible to essentially compensate for the direct coupling between the metal element 201 and the first receiving system 100.

However, in both cases under consideration, additional couplings can arise between the first rotor element 200 and the metal element 201, which likewise must be taken into account.

A minimization of the influence between first rotor element 200 and metal element 201 can be achieved when requirements are placed on the geometry of the first rotor element 200 and of the metal element 201, and a geometry such as is shown in FIG. 2 is used.

On account of the variation of the current over time, induction by the first rotor element 200 occurs in the metal element 201 and vice versa. When this occurs, the magnetic field of the first rotor element 200 changes on account of the metal element 201, which affects the voltage signals induced in the first receiving system 100. The influence here depends substantially on the geometry of the first rotor element 200 and of the metal element 201 as well as on the periodicities.

When the geometry shown in FIG. 2 is used, the following becomes apparent: For the application case shown in FIG. 3, it follows that an influence of the metal element 102 on the first rotor element 100, and thus on the first receiving system 100, arises that is independent of the angle of rotation in the case of a doubled periodicity of the metal element 201 with respect to that of the first rotor element 200. For the application case shown in FIG. 4, it is true that the change in the magnetic field of the first rotor element 200 caused by the metal element 201 uniformly affects the two receiving structure halves 403.1 and 403.2. Accordingly, no influence of the metal element 201 can be observed. Through the use of a geometry as shown in FIG. 2, it is therefore possible to cancel out the influence of the metal element 201 on the voltage signals induced in the first receiving system 100.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An inductive position sensor for a motor vehicle, the inductive position sensor comprising:
a first stator element that comprises a first excitation coil to which a periodic alternating voltage is applied, and also comprises a first receiving system, wherein the signal from the first excitation coil couples inductively into the first receiving system;
a first rotor element that influences a strength of the inductive coupling between the first excitation coil and the first receiving system as a function of its angular position relative to the first stator element;
a metal element, wherein the metal element and the first rotor element are arranged on a shaft in a rotationally fixed manner; and
an evaluation circuit to determine the angular position of the first rotor element relative to the first stator element from the voltage signals induced in the first receiving system,
wherein the first rotor element and the metal element are each designed as a conductor loop with a periodic geometry, and
wherein periodicities of the first rotor element and the metal element have a specified integer ratio.

2. The inductive position sensor according to claim 1, wherein the first stator element is arranged on a printed circuit board, wherein the printed circuit board is located in a space between the first rotor element and the metal element and at a distance therefrom, and wherein the printed circuit board is permeable to electric and/or magnetic fields and/or electromagnetic waves.

3. The inductive position sensor according to claim 1, wherein a geometry of the conductor loop of the first rotor element and of the metal element is described in each case by two circular paths with different radii about center points located on the shaft, wherein a first radius of a first of the two circular paths is smaller in than a second radius of a second of the two circular paths, and one section at a time of the conductor loop runs on the first or the second circular path periodically in alternation, and the ends of the sections are connected to the respective adjacent sections on the other respective circular path by a radial connection between the circular paths.

4. The inductive position sensor according to claim 1, wherein the section of the conductor loop on the circular path with the second radius forms a vane and the section of the conductor loop on the circular path with the first radius forms a gap, and wherein one vane and one gap, in each case, determine the periodicity of the first rotor element and of the metal element.

5. The inductive position sensor according to claim 1, wherein the ratio of the periodicities of the first rotor element and the metal element is 1:2 or 2:1.

6. The inductive position sensor according to claim 1, wherein the first receiving system has at least two or three, first conductor loops.

7. The inductive position sensor according to claim 6, wherein the first conductor loops each form a periodically repeating loop structure.

8. The inductive position sensor according to claim 7, wherein a winding direction of the first conductor loops of the periodically repeating loop structure changes, wherein an area is spanned as a result of the change in the winding direction.

9. The inductive position sensor according to claim 6, wherein the periodicity of the loop structure of each first conductor loop matches the periodicity of the geometry of the first rotor element.

10. The inductive position sensor according to claim 1, wherein the first rotor element and/or the metal element are designed as a stamped part and/or laser-cut part.

11. The inductive position sensor according to claim 1, wherein the metal element is a second rotor element.

12. The inductive position sensor according to claim 1, wherein a second stator element has a second excitation coil and a second receiving system with at least two or three, second conductor loops, wherein the signal from the second excitation coil couples into the second receiving system, and wherein the strength of the signal is influenced by the second rotor element.

13. The inductive position sensor according to claim 11, wherein a second stator element has a second receiving system with at least two or three, second conductor loops, wherein the signal from the first excitation coil couples into the second receiving system, and wherein the strength of the signal is influenced by the second rotor element.

14. The inductive position sensor according to claim 12, wherein the second stator element is arranged on a printed circuit board.
